(19) United States
(12) Patent Application Publication
(10) Pub. No.: US 2009/0014111 A1
(43) Pub. Date: Jan. 15, 2009

(54) METHOD OF MANUFACTURING DISPLAY DEVICE

(76) Inventors: Mi-Jung HAN, Yongin-si (KR); Seung-Jin Baek, Seoul (KR); Wang-Su Hong, Suwon-si (KR); Jeong-Ye Choi, Yongin-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/031,549

(22) Filed: Feb. 14, 2008

(30) Foreign Application Priority Data
Jul. 11, 2007 (KR) 10-2007-0069632

(51) Int. Cl. B29C 65/48

(52) U.S. Cl. 156/64; 156/182; 156/151

(57) ABSTRACT

A display device is manufactured by preparing first and second substrates, each being divided into a first region and a second region, forming a temporary attaching unit on the first region of the first substrate, attaching together the first regions of the first and second substrates, and attaching the second regions of the first and second substrates.

### CROSS-REFERENCE TO RELATED APPLICATION

This application claims priority to and the benefit of Korean Patent Application No. 10-2007-0069632, filed on Jul. 11, 2007, the disclosure of which is incorporated herein by reference in its entirety.

### BACKGROUND OF THE INVENTION

1. Field of the Invention

The present invention relates to a method of manufacturing a display device that prevents air bubbles and misalignment of substrates.

2. Description of the Related Art

Electrophoretic display devices possess the advantages of high reflection factor, high contrast ratio, low visual angle reliance and have some of the characteristics that make paper displays attractive. In addition, the electrophoretic display has a stable black or white state and can maintain images without the need for the continuous application of power. Further, unlike a liquid crystal display (LCD), the electrophoretic display does not need a polarizing plate, an orientation film, or liquid crystal and the like and so can be less expensive to manufacture.

The electrophoretic display comprises electrophoretic material including color-charged particles, a thin film transistor substrate for driving the electrophoretic material, and a color filter substrate for displaying colors. The electrophoretic material and its binder are formed in a film shape for attachment to the thin film transistor substrate using an adhesive layer.

However, the occurrence of an air bubble between the adhesive layer and the thin film transistor substrate, may distort the applied electric field, causing failure of the display. In addition, if the thin film transistor substrate is misaligned with respect to the color filter substrate, undesirable color mixing may occur.

### SUMMARY OF THE INVENTION

According to aspect of the present invention, air bubbles and misalignment between substrates of an electrophoretic display are prevented by temporarily attaching a first region of the substrates and then sequentially attaching remaining regions.

In accordance with an aspect of the present invention, there is provided a method of manufacturing a display device comprising the steps of preparing a first substrate and a second substrate, each being divided into a first region and a second region, forming a temporary attaching unit on the first region of the first substrate, attaching the first regions of the first and second substrates, and attaching the second regions of the first and second substrates.

The step of preparing the first and second substrates includes forming an electrophoretic layer on the second substrate.

The step of preparing of the first and second substrates further includes forming an adhesive layer and a release film on one side of the electrophoretic layer and then removing the release film.

The step of attaching the second regions of the first and second substrates further includes removing the release film.

The step of attaching the second regions of the first and second substrates further includes cutting the first and second substrates along cutting reference points.

The step of preparing the first and second substrates includes forming alignment reference points at the first and second regions of the first and second substrates.

The alignment reference points are formed on the first and second substrates, respectively, to correspond to each other.

In addition, any one of sealant, adhesive and fix jig is used as the temporary attaching unit.

The step of attaching the first regions of the first and second substrates further includes irradiating ultraviolet rays to the sealant, one of the temporary attaching units.

The step of attaching the first regions of the first and second substrates includes using an alignment monitoring device for managing the alignment of the first and second substrates through the alignment reference points.

The alignment monitoring device includes an image photographing device and an image display device.

The step of attaching the second regions of the first and second substrates includes using an absorption fixing unit for fixing the first and second substrates, the absorption strength of which is sequentially reduced from one side to the other side.

The step of attaching the second regions of the first and second substrates includes sequentially attaching from the first regions to second regions of the first and second substrates advantageously pressing the first and second substrates together using a roller.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram for explaining a display device which is manufactured by a manufacturing method of the display device according to an exemplary embodiment of the present invention;

FIG. 2 is a flow chart showing a manufacturing method of the display device according to an exemplary embodiment of the present invention;

FIGS. 3A and 3B are diagrams for explaining a step S11 of primarily cutting a first substrate and a second substrate shown in FIG. 2;

FIGS. 4A and 4B are diagrams showing first and second alignment reference points shown in FIGS. 3A and 3B;

FIG. 5 is a cross sectional view for explaining a step S12 of forming an electrophoretic layer on the second substrate shown in FIG. 2;

FIG. 6 is a diagram for explaining a step S13 of forming a temporary attaching unit on the first substrate shown in FIG. 2;

FIGS. 7 and 8 are diagrams for explaining a step S14 of aligning and then temporarily attaching the first and second substrates shown in FIG. 2;

FIGS. 9A and 9B are diagrams for explaining a step S15 of attaching the first and second substrates;

FIGS. 10A and 10B are diagrams for explaining a step S16 of secondarily cutting the first and second substrates;

FIG. 11 is a flow chart for explaining a manufacturing method of the display device according to another exemplary embodiment of the present invention; and

FIG. 12 is a diagram for explaining a step S25 of removing a release film shown in FIG. 11.

### DETAILED DESCRIPTION OF THE EXEMPLARY EMBODIMENT

For clear illustration, the widths of various layers and regions are enlarged in the drawings.

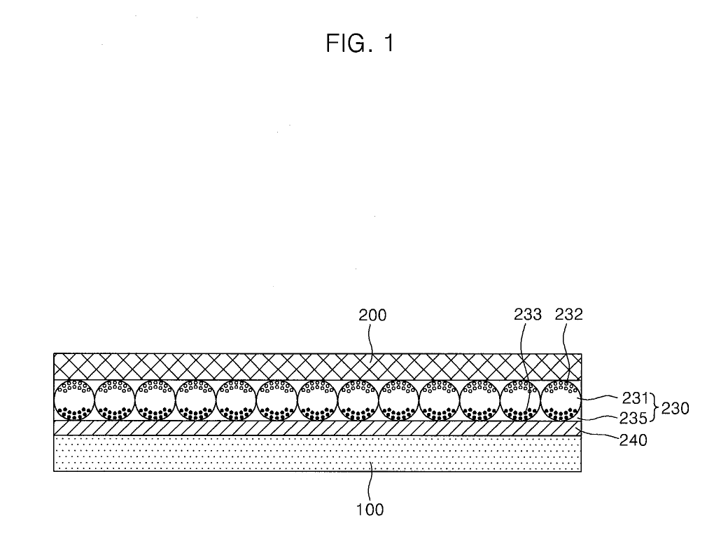

Referring to FIG. 1, the display device according to an exemplary embodiment of the present invention comprises a first substrate 100, an electrophoretic layer 230, and a second substrate 200. The first substrate 100 includes thin film transistors connected to gate lines and data lines, and a first electrode connected to the thin film transistors. The electrophoretic layer 230 is formed on the first substrate 100 and is comprised of micro capsules 231 including white and black charged particles 232 and 233 and a binder 235 fixing the micro capsules 231. The electrophoretic layer 230 and the first substrate 100 can be attached by using an adhesive. The second substrate 200 has a color filter and a second electrode and is formed on the electrophoretic layer 230.

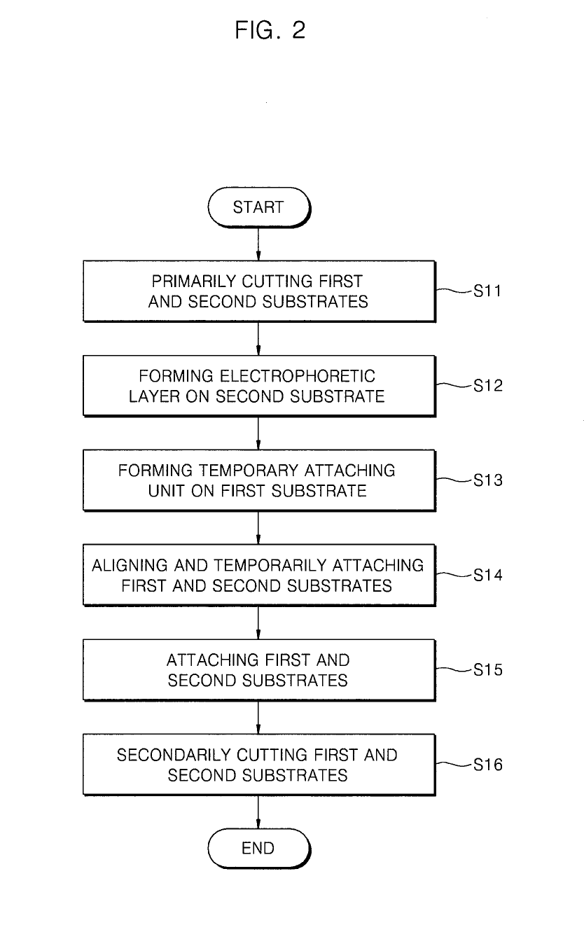

FIG. 2 is a flow chart showing the manufacturing method of the display device according to an exemplary embodiment of the present invention.

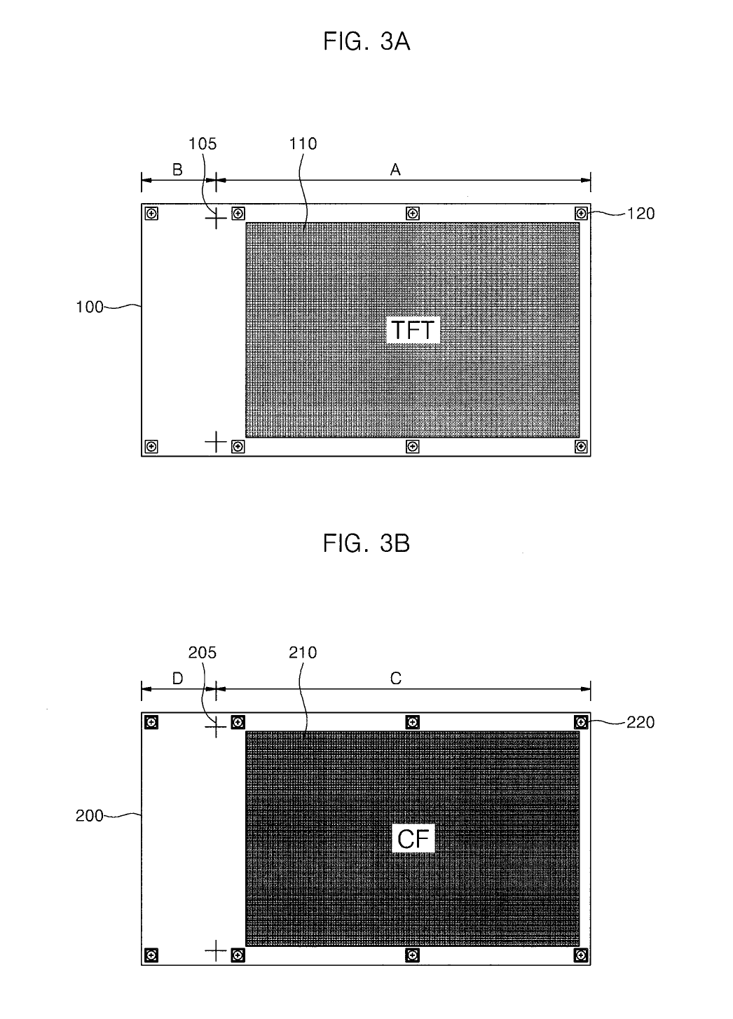

Referring to FIG. 2, the manufacturing method of the display device according to an exemplary embodiment of the present invention comprises a step S11 of primarily cutting the first and second substrates; a step S12 of forming the electrophoretic layer on the second substrate; a step S13 of forming a temporary attaching unit on the first substrate; a step S14 of aligning and temporarily attaching the first and second substrates; a step S15 of attaching the first and second substrates; and a step S16 of secondarily cutting the first and second substrates. Detailed description thereof will be made with reference to FIGS. 3A to 10B.

FIGS. 3A and 3B are diagrams for explaining the step S11 of primarily cutting the first and second substrates shown in FIG. 2.

First, as shown in FIGS. 3A and 3B, the first substrate 100 and the second substrate 200 constituting the display device are prepared. Each of the first and second substrates 100 and 200 is cut along a virtual line connecting primary cutting reference points (not shown) on a mother glass. The primary cutting reference points are not shown because FIGS. 3A and 3B illustrate the first substrate 100 and the second substrate 200 which were already cut along the virtual line connecting the primary cutting reference points.

The first substrate 100 is divided in a first region A and a second region B. The first and second regions A and B are divided by a virtual line connecting secondary cutting reference points 105. The first region A has a pixel region on which gate lines, data lines, thin film transistors and a first electrode are formed, and displays images via the pixel region. The second region B is a temporary region for attaching the second substrate 200 and does not display images.

The second substrate 200 is divided into a third region C and a fourth region D by secondary cutting reference points 205 in the same way as the first substrate 100. The second substrate 200 includes a second electrode and a color filter CF on the third region C. In addition, the fourth region D serves as a temporary region for attaching the second substrate 200 to the first substrate 100. The second substrate 200 may not include the color filter depending on the characteristics of the display device.

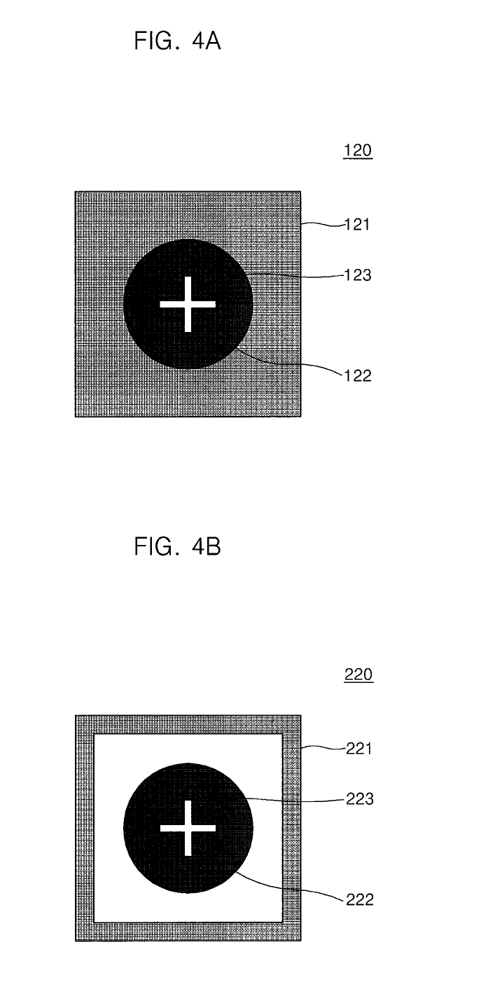

On the first and second substrates 100 and 200, first and second alignment reference points 120 and 220 are formed to correspond to each other. Here, at least more than one first alignment reference point 120 and at least more than one second alignment reference point 220 are formed on the first region A to the fourth region D of the first and second substrates 100 and 200. The first and second alignment reference points 120 and 220 will be described in detail with reference to FIGS. 4B and 4B.

FIGS. 4B and 4B are diagrams showing the first and second alignment reference points shown in FIGS. 3A and 3B.

As shown in FIG. 4B, the first alignment reference point 120 includes a first reference part 121 of a square shape, a second reference part 122 of a round shape and a third reference part 123 of a cross shape. The second reference part 122 is formed inside of the first reference part 121 to be projected with a predetermined depth, and the third reference part 123 is formed inside of the second reference part 122 in an engraving manner. The first alignment reference points 120 as described above may be made of opaque metal or organic matters. Here, a plurality of first alignment reference points 120 are formed on the first and second regions when forming a metal layer or an organic layer of the first substrate 100. For example, the first alignment reference points 120 are formed together when forming the thin film transistors or an organic layer of the first substrate.

As shown in FIG. 4B, the second alignment reference point 220 includes a fourth reference part 221 of a square frame shape with a predetermined width, a fifth reference part 222 of a round shape and a sixth reference part 223 of a cross shape. The fourth reference part 221, for example, is formed in a frame shape with a predetermined width like a picture frame. The fifth reference part 222 is formed inside of the fourth reference part 221 to have a predetermined depth, and the sixth reference part 223 is formed inside of the fifth reference part 222 in a groove shape. The sixth reference part 223 may be formed in the same groove shape as the third reference part 123 so that the third reference part 123 can be seen from the top. In addition, the second alignment reference point 220 may be made of opaque metal or organic matters like the first alignment reference point 120. Here, a plurality of second alignment reference points 220 are formed on the third and fourth regions when forming the metal layer or organic layer of the second substrate 200.

The first and second alignment reference points 120 and 220 according to an exemplary embodiment of the present invention are not limited to the above-described embodiment, but can be formed in various shapes to correspond to each other to be seen. For example, the first alignment reference point 120 and the second alignment reference point 220 can be formed on corresponding substrates to have a line or a surface that can be an alignment reference when seeing from the top.

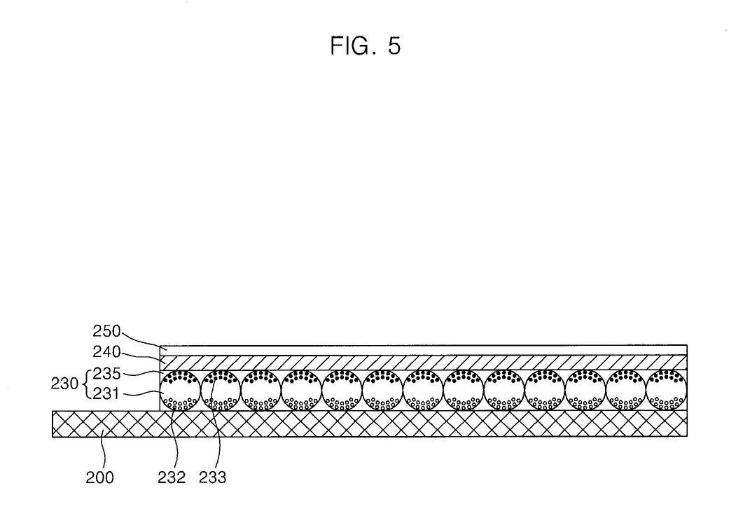

FIG. 5 is a cross sectional view for explaining the step S12 of forming the electrophoretic layer on the second substrate.

As shown in FIG. 5, the electrophoretic layer 230 is formed on the second substrate 200. The electrophoretic layer 230 is directly coated on the upper portion of the color filter of the second substrate 200 or attached thereto by using an electrophoretic sheet both sides of which are covered with adhesive.

More specifically, the electrophoretic layer 230 is comprised of micro capsules 231 having white and black charged particles 232 and 233, and a binder 235 for holding the micro capsules 231. Referring to a first method for forming the electrophoretic layer 230, the micro capsules 231 and the binder 235 are coated on the upper portion of the second substrate 200 to be thin. The electrophoretic layer 230 may be formed to have single layered micro capsules 231. Thereafter, an adhesive layer 240 is formed on the upper portion of the electrophoretic layer 230 and a release film 250 is attached on the upper portion of the adhesive layer 240.

Referring to a second method for forming the electrophoretic layer 230, the adhesive layer 240 is attached on both sides of the micro capsules 231 and binder 235 which are formed in a sheet shape. The adhesive layer between the second substrate 200 and the electrophoretic layer 230 is not illustrated. Next, the release film 250 is attached on the adhesive layer 240 that has been attached to one side of the electrophoretic layer 230. The adhesive layer attached to the other side of the electrophoretic layer 230 is laminated to the second substrate 200. The method for attaching the electrophoretic layer 230 is not limited to the laminating method, but other attaching methods can be applied thereto.

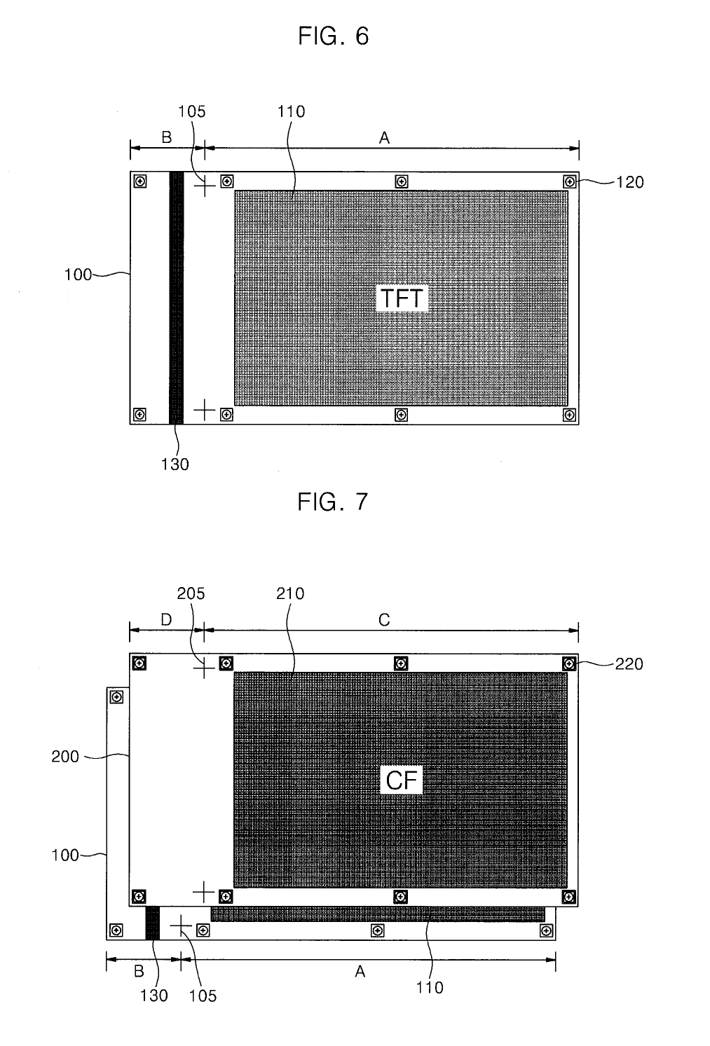

FIG. 6 is a diagram for explaining the step S13 of forming the temporary attaching unit on the first substrate shown in FIG. 2.

As shown in FIG. 6, the temporary attaching unit 130 is formed on the second region B of the first substrate 100.

The temporary attaching unit 130 is linearly formed inside of the second region B to be in parallel with the virtual line connecting the secondary cutting reference points 105. In addition, the temporary attaching unit 130 is formed in a linear shape with a predetermined width so that the first substrate 100 can be stably attached thereto. However, the temporary attaching unit 130 can also be formed in other shapes. For example, the temporary attaching unit 130 comprised of more than two points can be formed inside of the second region B.

In addition, the temporary attaching unit 130 is formed to be distanced from the virtual line connecting the secondary cutting reference points 105 by a predetermined distance. This is to remove the temporary attaching unit 130 together with the second region B of the first substrate 100 which is to be cut and removed at the time of secondary cutting. Additionally, the temporary attaching unit 130 may use a sealant or an adhesive. For example, the sealant may be made of the material which is hardened by ultraviolet rays. The temporary attaching unit 130 is not limited to the UV hardening sealant and adhesive, but various means for mechanical fixing like a fix jig can also be applied thereto.

FIGS. 7 and 8 are diagrams for explaining the step S14 of aligning and temporarily attaching the first and second substrates shown in FIG. 2.

As shown in FIGS. 7 and 8, the first and second substrates 100 and 200 are aligned and then temporarily attached by the temporary attaching unit 130. The second substrate 200 may be removed of the release film to be attached to the first substrate 100. More specifically, the first and second substrates 100 and 200 are aligned through the first and second alignment reference points 120 and 220 formed in the second region B and the fourth region D. The first and second substrates 100 and 200 are aligned after being fixed using absorption fixing units 310 and 330. For example, the first substrate 100 is fixed on a stage 310 and the second substrate 200 is fixed by an absorbing pad 335 of an absorber 330. And then the first and second alignment reference points 120 and 220 are monitored by the alignment monitor 320 to check the alignment of the first and second substrates 100 and 200. For example, the alignment monitor 320 takes pictures of the first and second alignment reference points 120 and 220 using an image photographing device like a camera and monitors the images through an image display device therein. Next, the second and fourth regions B and D of the first and second substrates 100 and 200 are attached by using the temporary attaching unit 130. The unattached region of the second substrate 200 is placed to be inclined against the first substrate 100 by using the absorber 330.

UV hardening of the sealant for the temporary attaching unit 130 may include irradiating the sealant formed between the second and fourth regions B and D to firmly attach together the second and fourth regions B and D.

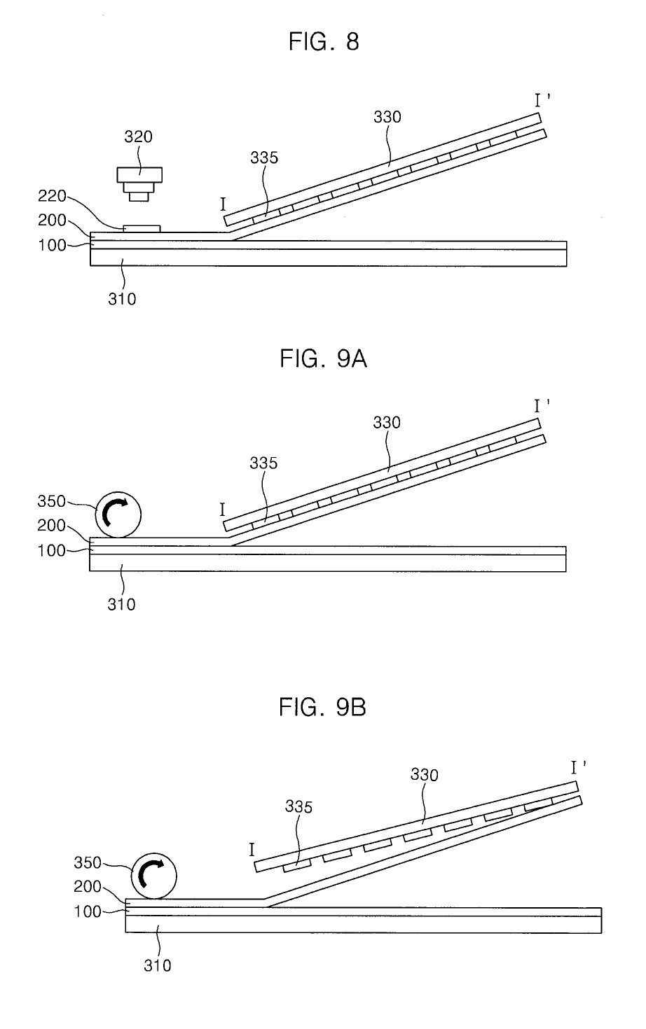

FIGS. 9A and 9B are diagrams for explaining the step Si 5 of attaching the first and second substrates shown in FIG. 2.

As shown in FIGS. 9A and 9B, the first substrate 100 is attached to the second substrate 200.

A roller 350 is placed on the upper portion of the temporarily attached regions of the first and second substrates 100 and 200. The unattached region of the second substrate 200 is inclined against the first substrate 100 using the absorber 330. Next, the roller 350 is moved from the attached region to the unattached region. The absorber 330 sequentially removes the absorbing strength from one part I to the other part I′, thereby gradually separating the second substrate 200. The roller 350 attaches the second substrate 200 separated from the absorber 330 to the first substrate 100, with rotating in a processing direction. Accordingly, the second substrate 200 is sequentially attached to the first substrate 100 from one side to the other side, preventing the generation of air bubbles therebetween.

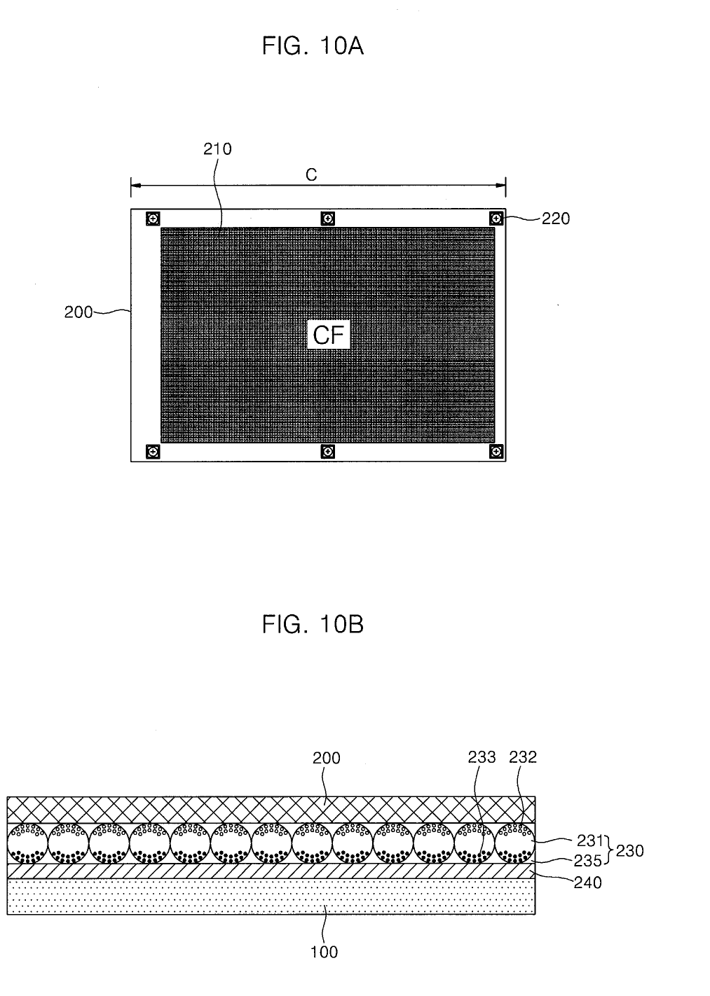

FIGS. 10A and 10B are diagrams for explaining the step S16 of secondarily cutting the first and second substrates.

As shown in FIGS. 10A and 10B, the first and second substrates 100 and 200 are secondarily cut. More specifically, the attached first and second substrates 100 and 200 are cut along the virtual line connecting the secondary cutting reference line formed on the second substrate 200. Thereby, only the first and third regions A and C are left on the first and second substrates 100 and 200. The secondary cutting reference line is not illustrated here because FIG. 10A shows the second substrate 200 which was already cut along the virtual line connecting the secondary cutting reference line. Referring to FIG. 10B, the electrophoretic layer 230 and the adhesive layer 240 are formed between the first and second substrates 100 and 200, thus forming the electrophoretic display device. Thereby, it is possible to describe the manufacturing method of the electrophoretic display device through the above-described manufacturing method of the display device according to an exemplary embodiment of the present invention.

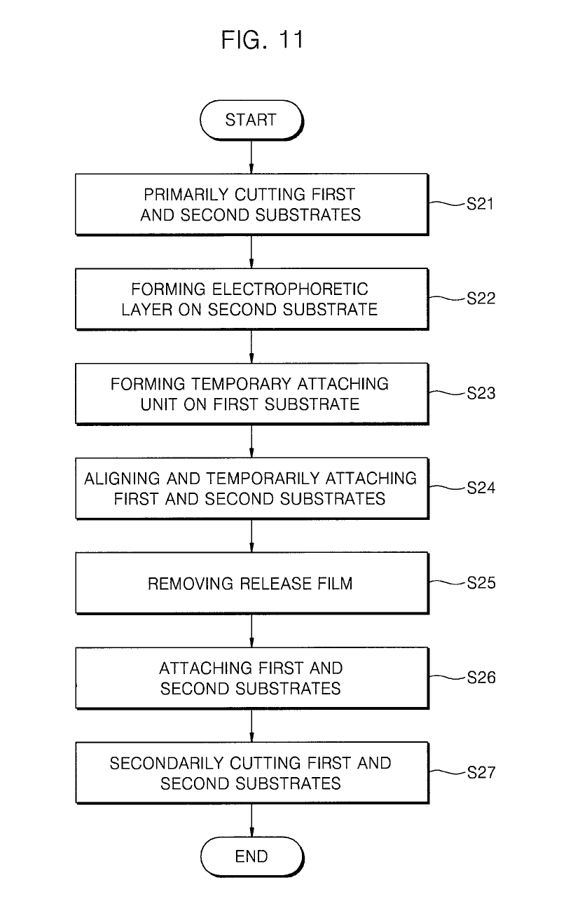

The method of manufacture of the display device according to another exemplary embodiment of the present invention will be described with reference to FIG. 11.

FIG. 11 is a flow chart for explaining the manufacturing method of the display device according to another exemplary embodiment of the present invention.

Referring to FIG. 11, the manufacturing method of the display device according to another exemplary embodiment of the present invention comprises a step S21 of primarily cutting the first and second substrates; a step S22 of forming the electrophoretic layer on the second substrate; a step S23 of forming a temporary attaching unit on the first substrate; a step S24 of aligning and temporarily attaching the first and second substrates; a step S25 of removing the release film; a step S26 of attaching the first and second substrates; and a step S27 of secondarily cutting the first and second substrate.

The manufacturing method of the display device according to another exemplary embodiment of the present invention shown in FIG. 11 includes identical steps to some steps of the manufacturing method of the display device according to an exemplary embodiment of the present invention shown in FIG. 2. Accordingly, the drawings on the manufacturing method of the display device according to an exemplary embodiment of the present invention will be referenced for the description on the identical steps of the manufacturing method of the display device according to another exemplary embodiment of the present invention, but the detailed description thereof will be omitted.

In the step S21 of primarily cutting the first and second substrate, the first and second substrates 100 and 200 are cut along the virtual line connecting the primary cutting reference points (not shown) on the mother glass, as shown in FIGS. 3A and 3B. The first and second alignment reference points 120 and 220 are formed on the first and second substrates 100 and 200 to correspond to each other.

Next, in the step S22 of forming the electrophoretic layer on the second substrate, the electrophoretic layer 130 is directly coated or attached in a sheet form onto the second substrate 200, as shown in FIG. 5.

In the step S23 of forming the temporary attaching unit on the first substrate, the temporary attaching unit 130 of linear shape or the temporary attaching unit comprised of more than two points is formed on the second region B of the first substrate 100 to be in parallel with the virtual line connecting the secondary cutting reference points 105, as shown in FIG. 6.

In the step S24 of aligning and temporarily attaching the first and second substrates, the first and second substrates 100 and 200 are aligned through the first and second alignment reference points 120 and 220 and then attached to each other by using the temporary attaching unit 130, as shown in FIGS. 7 and 8. The second substrate 200 may be not removed of the release film. Accordingly, since the second substrate 200 is not attached to the first substrate 100 by the release film, it does not need to fix the unattached region of the second substrate 200 by the absorber.

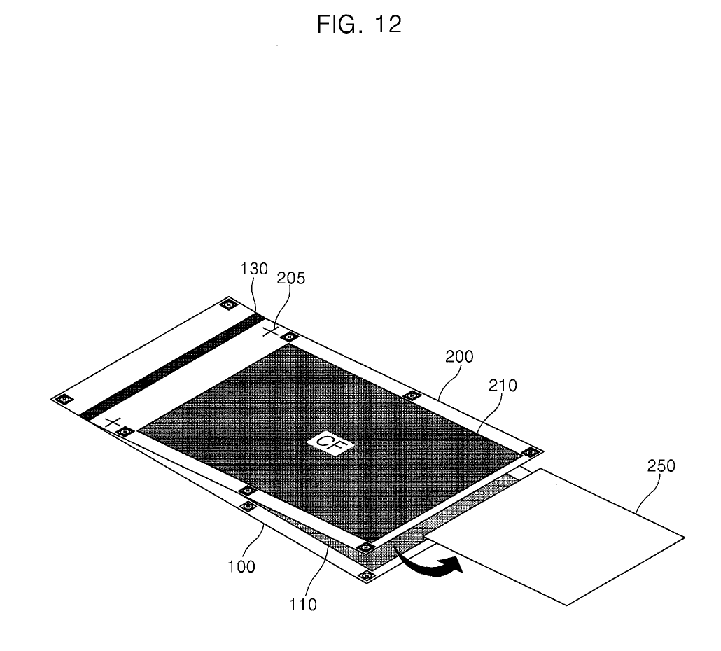

Next, the step S25 of removing the release film will be described in detail with reference to FIG. 12. FIG. 12 is a diagram for explaining the step S25 of removing the release film shown in FIG. 11.

Referring to FIG. 12, the release film 250 is removed from the second substrate 200. Since one side of the second substrate 200 is attached to the first substrate 100 by the temporary attaching unit 130, the release film 250 is sequentially removed from the part closer to the temporary attaching unit 130 to the part away from the temporary attaching unit 130. The release film 250 may be carefully removed not to damage the surface of the first substrate 100. In addition, the release film 250 may be removed in the state that the second substrate 200 is fixed.

In the step S26 of attaching the first and second substrates, the roller 350 is placed on the upper portion of the temporary attached region of the first and second substrates 100 and 200 and then rotates to sequentially attach the first and second substrates 100 and 200, as shown in FIGS. 9A and 9B.

In the step S27 of secondarily cutting the first and second substrates, the first and second substrates 100 and 200 are cut along the virtual line connecting the secondary cutting reference line. Thereby, the first and second substrates 100 and 200 are attached to each other with the electrophoretic layer 230 and the adhesive layer 240 being formed therebetween, thus forming the electrophoretic display device.

The manufacturing method of the display device according to the exemplary embodiments of the present invention is not limited to the manufacturing method of the electrophoretic display device, but it is also applicable to a manufacturing method of the display device that sequentially attaches the first and second substrates 100 and 200 in other ways like lamination.

As described above, the manufacturing method of the display device according to the present invention temporarily attaches a region of the first and second substrates on which the alignment reference points are formed, and then sequentially attaches the remaining regions, thereby preventing misalignment of the first and second substrates. In addition, the manufacturing method of the display device aligns the first and second substrates by using the alignment monitoring device and the absorption fixing unit, thereby preventing misalignment and improving productivity. Further, the manufacturing method of the display device sequentially attaches the first and second substrates from one side to the other side, thus preventing the generation of air bubbles. Thereby, it is possible to prevent the display failure due to the air bubbles.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of manufacturing a display device, comprising:
preparing a first substrate and a second substrate, each being divided into a first region and a second region;
forming a temporary attaching unit on the first region of the first substrate;
attaching the first regions of the first and second substrates; and
attaching the second regions of the first and second substrates.

2. The method according to claim 1, wherein the step of preparing the first and second substrates comprises forming an electrophoretic layer on the second substrate.

3. The method according to claim 2, wherein the step of preparing the first and second substrates further comprises forming an adhesive layer and a release film on one side of the electrophoretic layer.

4. The method according to claim 3, wherein the step of preparing the first and second substrates further comprises removing the release film.

5. The method according to claim 3, wherein the step of attaching the second regions of the first and second substrates further comprises removing the release film.

6. The method according to claim 1, wherein the step of attaching the second regions of the first and second substrates further comprises cutting the first and second substrates along cutting reference points.

7. The method according to claim 1, wherein the step of preparing the first and second substrates further comprises forming alignment reference points on the first and second regions of the first and second substrates.

8. The method according to claim 7, wherein the alignment reference points are formed on the first and second substrates to correspond to each other.

9. The method according to claim 1, wherein the temporary attaching unit uses any one of a sealant, an adhesive and a fix jig.

10. The method according to claim 9, wherein the step of attaching the first regions of the first and second substrates further comprises irradiating ultraviolet rays to the sealant, one of the temporary attaching units.

11. The method according to claim 1, wherein the step of attaching the first regions of the first and second substrates further comprises using an alignment monitoring means for managing the alignment of the first and second substrates through the alignment reference points.

12. The method according to claim 11, wherein the alignment monitoring means comprises an image photographing device and an image display device.

13. The method according to claim 1, wherein the step of attaching the second regions of the first and second substrate further comprises using an absorption fixing unit for fixing the first and second substrates.

14. The method according to claim 13, wherein the absorbing strength of the absorption fixing unit is sequentially reduced from one side to the other side.

15. The method according to claim 1, wherein the step of attaching the second regions of the first and second substrates further comprises sequentially attaching from the first regions of the first and second substrates to the second regions of the first and second substrates.

16. The method according to claim 15, wherein the step of attaching the second regions of the first and second substrates further comprises attaching the first and second substrates by pressing them with a roller.
